(19) United States
(12) Patent Application Publication
(10) Pub. No.: US 2002/0147648 A1
(43) Pub. Date: Oct. 10, 2002

(54) Apparatus and method for selling merchandise at fuel dispensers

(76) Inventors: Chris Fadden, Cold Spring, NY (US); Seamus Carroll, Cold Spring, NY (US); Eric Spector, Wilton, CT (US); Al Spahn, Wanaque, NJ (US)

Correspondence Address: Norman H. Zivin, Cooper & Dunham, LLP, 1185 Avenue of the Americas, New York, NY, 10036, US

(21) Appl. No.: 09/906,637

(22) Filed: Jul. 16, 2001

Related U.S. Application Data
(63) Continuation-in-part of application No. 09/829,814, filed on Apr. 10, 2001.

(51) Int. Cl. G06F 17/60

(52) U.S. Cl. 705/16

(57) ABSTRACT

An apparatus and a method are provided for selling at a fuel dispenser merchandise to be shipped to the customer. A point-of-sale (POS) kiosk is provided in a physical proximity of the fuel dispenser. The POS kiosk has a controller and a communication interface. The controller monitors whether fuel is dispensed by the fuel dispenser. A user interface through which a user can select a desired merchandise is provided, after it is determined that fuel is being dispensed by the fuel dispenser. The POS kiosk communicates electronically through the communication interface to obtain customer information corresponding to a shipping address for the selected merchandise from a credit agency and/or a database, with minimal or no input of information by the user for obtaining the shipping address.

### CROSS-REFERENCE TO RELATED APPLICATIONS

This application is a continuation-in-part of U.S. patent application Ser. No. 09/829,814, filed Apr. 10, 2001 and entitled “APPARATUS AND METHOD FOR SELLING LOTTERY TICKETS AT FUEL DISPENSERS”.

### BACKGROUND OF THE INVENTION

The present invention relates to marketing merchandise at fuel dispensers. In particular, the invention relates to selling merchandise through point-of-sale kiosks at retail fuel dispensers, with the merchandise being shipped to the customer.

Technology and opportunity have converged, presenting many opportunities to market merchandise by using new age media for a traditional enterprise. Marketing opportunities may take advantage of, for example, consumers' desire for convenience and tendency towards impulse purchases. In particular, consumers may be more inclined to purchase merchandise for which they previously did not express a need, if marketing messages that make the merchandise appealing to the consumer are delivered when the consumer is already in the process of purchasing other items. Additional marketing opportunities may be available in the middle of a purchase cycle when a consumer is not occupied by activities requiring the consumer's full attention, such as while refueling the consumer's vehicle at a gas station.

Recently, some gas stations, as well as convenience stores with gas dispensers near the storefront, are providing facilities at the gas dispenser island for customers to purchase merchandise, such as automotive products and other items that are normally available in the gasoline station office or convenience store, and services, such as a car wash, without entering the gasoline station office or convenience store. Such gas dispensers typically have integrated pay-at-the-pump means, such as cash acceptors and card readers.

It has been proposed, such as in U.S. Pat. Nos. 5,945,975 and 6,152,591, to provide advertisements and other messages on a graphic/video display at the gas pump. Thus, messages intended to trigger the consumer's impulses for buying merchandise available at the gas station or convenience store may be displayed. Merchandise and services not available at the gasoline station or convenience store also may be advertised. The mere display of advertisements for merchandise and services not available at the station/store does not, however, take advantage of impulse purchase tendencies during the time the consumer is at a gas dispenser.

### SUMMARY OF THE INVENTION

The present invention provides an apparatus for selling merchandise selected by a customer for purchase at a fuel dispenser, wherein the purchased merchandise is to be shipped to the customer. The apparatus comprises, in accordance with one embodiment, an electronic communication interface and a controller. The electronic communication interface comprises an interface adapted to communicate electronically with the fuel dispenser. The controller is coupled to the communication interface to communicate with the fuel dispenser, and is adapted to monitor whether the fuel dispenser is being used. After determining that the fuel dispenser is being used, the controller triggers a user interface through which a user can select merchandise for purchase, and obtains through the communication interface customer information corresponding to a shipping address for the selected merchandise, without any input in some cases, or minimal input in other cases, of information by the user for obtaining the shipping address. The user interface may display the shipping address, or an abbreviated version of the shipping address, and request confirmation by the customer.

The apparatus may be a kiosk unit distinct from the fuel dispenser. In accordance with another embodiment, the POS kiosk may be integrated within a housing of the fuel dispenser.

The apparatus communicates electronically with the fuel dispenser through the communication interface and, in accordance with one embodiment, a kiosk server. In accordance with another embodiment, the apparatus communicates electronically with the fuel dispenser through the communication interface and a network dispenser interface. In accordance with another embodiment, the apparatus communicates electronically with the fuel dispenser through the communication interface, the kiosk server and the network dispenser interface.

The apparatus may communicate electronically with a credit agency (or other bank or financial institution) and/or a database to obtain the customer information through the communication interface and, in accordance with one embodiment, a kiosk server. In accordance with another embodiment, the apparatus communicates electronically with the credit agency and/or the database to obtain the customer information through the communication interface and a network dispenser interface. In accordance with another embodiment, the apparatus communicates electronically with the credit agency and/or the database to obtain the customer information through the communication interface, the kiosk server and the network dispenser interface.

It should be noted that while reference is made herein to a credit agency, the references apply similarly to other bank or financial institutions.

The communication interface further may comprise a second interface adapted to communicate electronically with a remote database, wherein the controller obtains from the remote database through the second interface the customer information corresponding to the shipping address for the selected merchandise. The customer information obtained from the remote database may include a mailing address of the customer. The customer information obtained from the remote database may include a code for obtaining a mailing address of the customer. The remote database may be associated with a Web site. Thus, the customer may complete a transaction by one-push ordering (described further below).

The apparatus further may comprise a card reader coupled to the controller, and the electronic communication interface further may comprise a second interface adapted to communicate electronically with a consumer record database provider, wherein the controller receives card data obtained by the card reader from a transaction card (for example, a credit card, a debit card or other financial transaction card) supplied by the customer, communicates the card data to the consumer record database provider and receives a confirmation along with cardholder address information from the consumer record database provider, through the second interface, and uses the cardholder address information to identify the shipping address for the selected merchandise. In accordance with another embodiment, the card reader is integrated within a housing of the fuel dispenser, and the controller receives through the electronic communication interface the card data obtained by the card reader.

In accordance with another embodiment, the communication interface further comprises a second interface adapted to communicate electronically and wirelessly with a transponder device in a vehicle or a possession of the customer, and the controller obtains customer identification information through the second interface from the transponder device. The controller may obtain customer address information through the second interface from the transponder device and uses the customer address information to identify the shipping address for the selected merchandise. The selected merchandise may include digital media, and the digital media may be delivered to the customer through the second interface.

The communication interface further may comprise a third interface adapted to communicate electronically with a consumer record database provider, wherein the controller communicates through the third interface the customer identification information and receives a confirmation along with the customer address information from the consumer record database provider.

In accordance with another embodiment, the communication interface further comprises a second interface adapted to communicate electronically with a supplier and/or fulfillment center of the selected merchandise, wherein the controller prepares an electronic purchase order for the selected merchandise, including the information corresponding to the shipping address, and communicates the electronic purchase order through the second interface to the supplier. The user interface may comprise a voice interface including a voice recognition component.

The apparatus further may comprise a printer, wherein a confirmation of the purchase order for the selected merchandise is printed by the printer. In accordance with another embodiment, the printer is integrated within a housing of the fuel dispenser, and the controller communicates with the fuel dispenser through the electronic communication interface to have the printer print a confirmation of the purchase order for the selected merchandise.

The present invention also provides a method for selling merchandise selected by a customer for purchase at a fuel dispenser, comprising, in accordance with one embodiment, (a) providing a POS kiosk in a physical proximity of the fuel dispenser, wherein the POS kiosk has a controller and a communication interface, (b) monitoring through the controller whether fuel is dispensed by the fuel dispenser, (c) providing a user interface through which a user can select a desired merchandise, after it is determined in step (b) that fuel is being dispensed by the fuel dispenser, and (d) communicating electronically from the POS kiosk through the communication interface to obtain customer information corresponding to a shipping address for the selected merchandise, with minimal or no input of information by the user for obtaining the shipping address.

In accordance with another embodiment, the method comprises (a) monitoring through the controller whether fuel is dispensed by the fuel dispenser, (b) providing a user interface through which a user can select a desired merchandise, after it is determined in step (a) that fuel is being dispensed by the fuel dispenser, and (c) communicating electronically from the POS kiosk through the communication interface to obtain customer information corresponding to a shipping address for the selected merchandise, with minimal or no input of information by the user for obtaining the shipping address.

In accordance with one embodiment, the method further comprises receiving a signal at the POS kiosk from the fuel dispenser when a fuel purchase transaction commences at the fuel dispenser. In accordance with another embodiment, the method further comprises receiving a signal at the POS kiosk from the fuel dispenser when a fuel pump handle at the fuel dispenser has been lifted from a resting position.

The method further may comprise adding to a fuel purchase transaction at the fuel dispenser a purchase of the selected merchandise.

### BRIEF DESCRIPTION OF THE DRAWINGS

The above and numerous other objectives, features and advantages that may be achieved by the present invention would be more readily understood from the following detailed description by referring to the accompanying drawings wherein:

FIG. 1A shows a view of a fuel dispenser and a POS kiosk, wherein the kiosk is a distinct unit from the fuel dispenser, according to one embodiment of the present invention;

FIG. 1B shows a view of a fuel dispenser with a POS kiosk integrated within a housing of the fuel dispenser, according to another embodiment of the present invention;

FIG. 1C shows a view of a fuel dispenser and a POS kiosk, wherein the kiosk is a distinct unit from the fuel dispenser and is adapted to include a card reader, according to another embodiment of the present invention;

FIG. 2A shows a schematic view of communication between the POS kiosks and fuel dispensers shown in FIGS. 1A-1C on the one hand, and a credit agency and/or database on the other hand, according to an embodiment of the present invention;

FIG. 2B shows a schematic view of communication between the POS kiosks shown in FIGS. 1A-1C on one hand and the fuel dispensers (shown in FIGS. 1A-1C) and a credit agency and/or database on the other hand, according to another embodiment of the present invention;

FIG. 2C shows a schematic view of communication between the POS kiosks shown in FIGS. 1A-1C on one hand and the fuel dispensers (shown in FIGS. 1A-1C) and a credit agency and/or database on the other hand, according to another embodiment of the present invention;

FIG. 2D shows a schematic view of communication between the POS kiosks and fuel dispensers, as shown in FIG. 2A, with an optional controller added, according to another embodiment of the present invention; and

FIG. 3 shows a block diagram of a system including any one of the POS kiosks shown in FIGS. 1A-1C and 2A-2C.

### DETAILED DESCRIPTION OF THE INVENTION

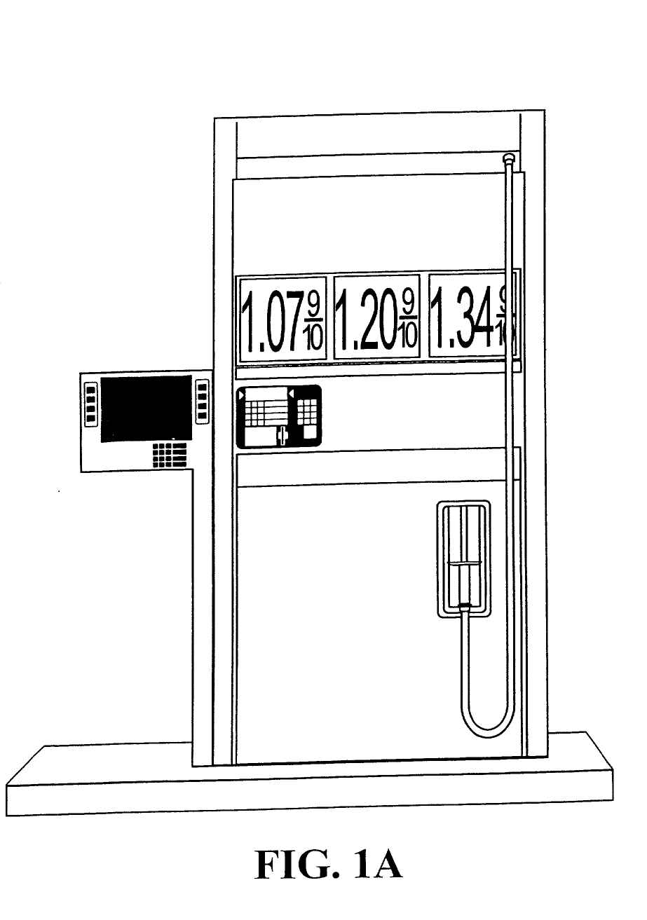

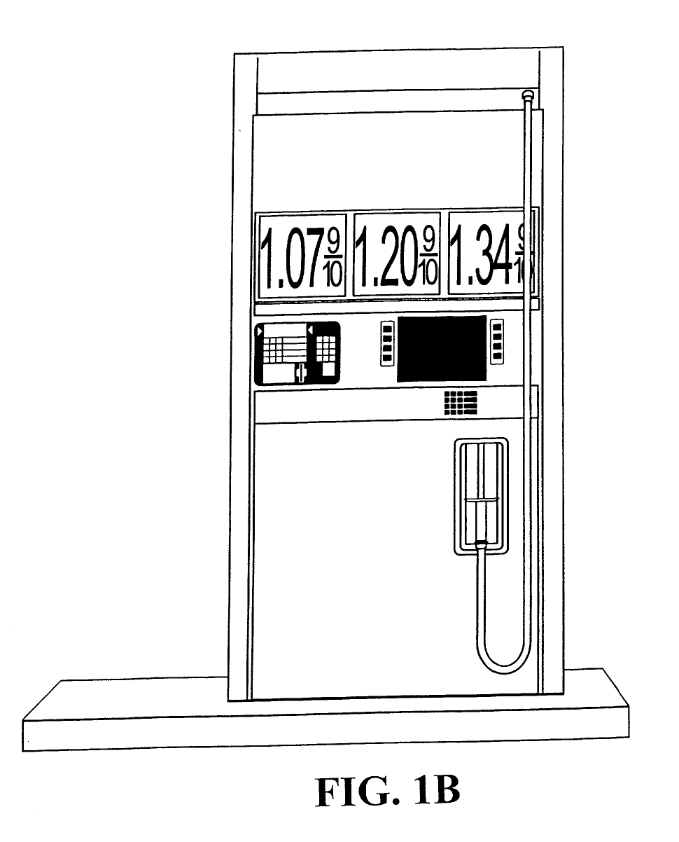

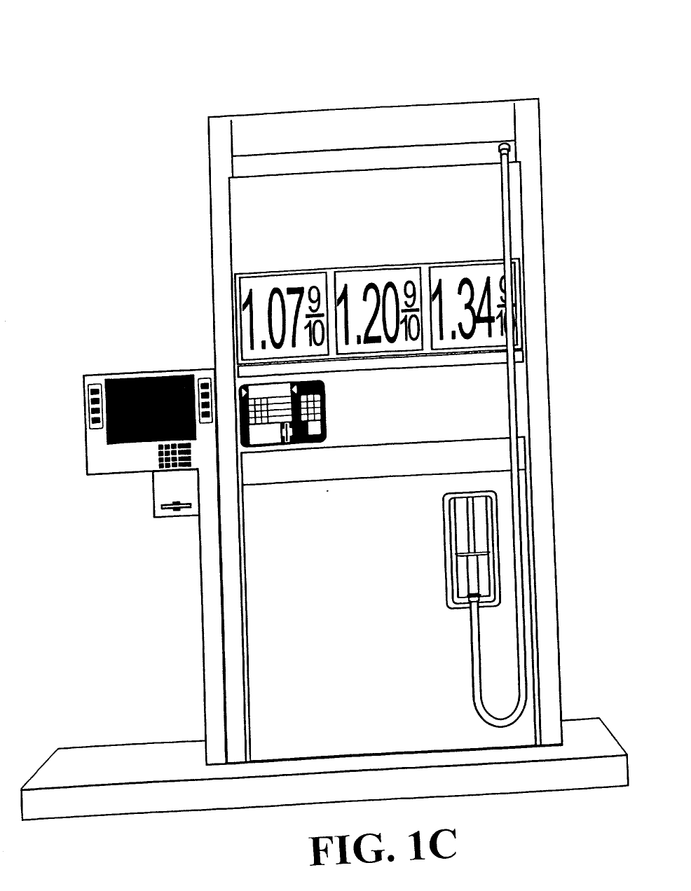

In accordance with the present invention, merchandise to be shipped to a purchaser is sold at a fueling location through a point-of-sale (POS) kiosk with an electronic interface for communicating electronically with a fuel dispenser. The kiosk may be a separate unit next to the fuel dispenser (see, for example, FIG. 1A), or integrated within a housing of the fuel dispenser (see, for example, FIG. 1B).

The kiosk may be triggered by operation at the fuel dispenser in the following manner, in accordance with one embodiment. The kiosk waits for a signal from the dispenser through a network dispenser interface, kiosk server or other server which indicates that the pump handle has been lifted or a transaction card (for example, credit card, debit card, convenience card, etc.) has been swiped through a card reader at the dispenser. The kiosk then runs through its user interface program, while the gas pump is operated to refuel a vehicle in a conventional fashion. For example, an infomercial for a merchandise may be presented on a video display at the kiosk, while the vehicle is being refueled. The kiosk continually checks with the dispenser to determine if the pump handle has been placed back into the dispenser. After the handle replacement is signaled, the kiosk completes the current video segment and terminates the display program. If the customer purchases merchandise through the kiosk or requests a coupon, the receipt or coupon may be printed on a receipt printer of the fuel dispenser or on a printer integrated with the kiosk.

A customer at the fuel dispenser to purchase gasoline may swipe his/her transaction card through the card reader integrated with the dispenser. After the card is swiped, card data and transaction data may be transmitted telecommunicatively to an appropriate credit agency or other bank or financial institution for approval of credit for the fuel purchase transaction. In addition, the card data, in accordance with one embodiment, also may be forwarded from the fuel dispenser through the network dispenser interface, kiosk server or other server to the kiosk, and the received data is held at the kiosk pending a transaction at the kiosk and/or completion of the gasoline purchase transaction.

In another embodiment, the card/identification data may, also or alternatively, be provided through other techniques, for example, RF transmission, EZ Pass, key tag (such as Mobil Speed Pass), and other technologies. Further, payment may be accepted through cash acceptors, in addition to card readers, installed in the fuel dispenser and/or in the kiosk.

The customer may decide to purchase one or more merchandise items by pressing a button, for example, on the kiosk or graphically shown on a touchscreen display at the kiosk. After the button is pressed, various selection features, may be provided on the display. For example, the customer may be prompted, in accordance with one embodiment, to operate a numeric or conventional numeric keypad to select the desired merchandise. In accordance with another embodiment, the customer may pre-store a list of his/her favorite or desired merchandises in a database, e.g., at a Web site, and the customer is prompted at the kiosk to specify whether he/she wants to retrieve the stored list of merchandises. In any event, while the user is provided with sufficient means to select the merchandise he/she desires, it is generally desirable to minimize the amount of, and simplify, user operation, for example, for providing transaction and credit data.

After the user has completed selection of desired merchandise to be purchased, transaction data for the transaction and the card data may be sent out through an electronic communication interface to the credit agency for approval of credit for the purchase. If the transaction is approved by the credit agency, the kiosk communicates with the credit agency, to receive a confirmation and customer information from the credit agency. The customer information received from the credit agency may be used to determine a shipping address for the merchandise. The shipping address then may be displayed and/or a receipt printed on a receipt printer integrated with the gas dispenser or a printer at the separate kiosk unit. Thus, the customer may purchase merchandise not available at the gas station/store.

The merchandise purchase may total only a few dollars, and therefore may not be enough (and it may not be efficient) to constitute a separate credit card transaction. Accordingly, if conditions permit, the merchandise purchase may be added to the gas purchase. On the other hand, the merchandise purchase may also be completed in a completely separate transaction.

The kiosk may have a high quality, interactive display screen (for example, large flat panel display), and may be located at a high consumer traffic location, such as near a gas pump at a high-volume retail gas station. The vicinity of the gas pump provides a particularly suitable venue because consumers are captive viewers while pumping gas. Therefore, the display screen may be located at the side of the pump to allow the consumer to look at something other than the gas pump and be occupied by messages on the display screen.

Timely and essential information, as well as highly targeted advertising content, may be delivered visually to the consumers while they are in the process of pumping gasoline at the gas pump. The advertising content may be delivered during a typical 3.5 minute average viewing time, when the typical consumer is at the pump. This is a suitable time to advertise related automotive products or other merchandise available in the gas station or adjoining convenience store, since the consumer at the gas pump has already entered the purchase cycle by initiating a gasoline purchase transaction.

Selective, current and relevant content may be shown on the display to each consumer once the consumer has swiped his/her transaction card or begun the fueling cycle. For example, the display screen may inform the consumer of breaking news, traffic, sports and local weather. In addition, merchandise sold in the convenience store or the gas station, as well as other products the consumer may purchase while at the pump, may be advertised on the display screen. The electronic nature of the content displayed on the display screens allows the content to be changed rapidly to suit fast moving advertising and sales opportunities.

Programming, advertising and product offerings may be tailored to the individual consumer based on profiles, including specific consumer profile and/or demographics, that are maintained in a centralized database and, periodically or upon request, downloaded to the kiosk through the network dispenser interface, kiosk server or other server. Thus, the advertising may be “waste-free” and the probability of the consumer consummating a targeted transaction may be maximized.

The advertising may target specific demographics and viewers. A message may have an associated category profile. The targeted advertising clip may be shown only to those customers who, based on the card data and/or stored information corresponding to the consumer, meet the selected profiles. The advertiser may be billed only for showing their message to those customers who meet the selected profile, and thereby obtains the benefit of savings by not paying to reach less desirable consumers who do not meet the targeted profile. Thus, advertisers may target specific demographics and reach only those consumers who meet a particular profile.

Merchandise offerings may be targeted by language, culture, income, region, buying habits and other criteria. Content played at one kiosk may be different from nearby kiosks. Messages, content, advertising and merchandising may be changed quickly and tailored to the time of day. Also, the presentations may be adjusted based on specific consumer profile, and thus the probability of consummating transactions with any particular consumer may be increased.

Products may also be offered for sale via selected short product infomercials shown on the display. For example, easily recognizable products commonly purchased on impulse, such as compact disks, videotapes, DVDs, books and other items may be offered.

“Soft” pushbuttons (such as now available on many ATM terminals) may be provided adjacent to the main message screen, so that the consumer has means to interact with the messages, advertisements and short product infomercials displayed on the main screen. More importantly, it allows the consumer to initiate an immediate purchase of merchandise without waiting on a line or any interaction with store personnel. When the consumer initiates the purchase of a product, the consumer's transaction card may be charged upon confirmation that the item has been shipped to the consumer. For merchandises that are not at the station/store, an electronic order may be automatically forwarded to the merchandise manufacturer or the fulfillment jobber, and the purchased merchandise may be shipped directly to the consumer. For example, the item(s) may be shipped to the consumer's registered card address. For cash customers, the item(s) may be shipped to, for example, an address corresponding to a published telephone number or any other appropriate method to obtain the appropriate shipping address.

In accordance with the present invention, merchandise is sold at or near a fuel dispenser (for example, a gas pump) through a POS kiosk. The kiosk may be a distinct physical structure or may be integrated in the fuel dispenser. In an embodiment in which the kiosk is integrated inside the dispenser housing, the fuel dispenser may be modular to allow other features and options to be added later. These options might include a cash acceptor or a video screen. When the kiosk is integrated into the dispenser housing, it may remain separate from the fuel dispenser, and not control or affect the fueling process. Thus, in an event of failure of the kiosk, the fuel dispenser continues to operate in a normal fashion.

A user may select merchandise by pressing a button on the fuel dispenser or, in an embodiment in which the kiosk is a separate unit from the fuel dispenser, on the kiosk located next to the fuel dispenser, or by pressing a graphical button on a touchscreen display. The merchandise may be purchased by using a card reader/cash acceptor integrated in the fuel dispenser or in the separate kiosk unit (see, for example, FIG. 1C), to make payment. The purchase may be added to a gasoline purchase transaction at the fuel dispenser or executed as a separate transaction from the gasoline purchase, and a receipt is printed on the receipt printer at the fuel dispenser or a printer in the kiosk. Instant prize coupons for discounts on store merchandise and free goods also may be printed.

The POS kiosk may include the feature of “one-push” ordering. The consumer provides all the required consumer information (for example, name, address, telephone number, ship-to address, credit card information, etc.) at a web site (or through another medium, such as telephone), and the entered information is stored in a database. If and when the consumer uses a credit card that has been registered at the web site (or otherwise), the kiosk is able to retrieve the consumer information from the database by supplying the credit card data. Thus, the consumer may purchase merchandise by pressing one button at the kiosk (and perhaps also a second button to confirm the order).

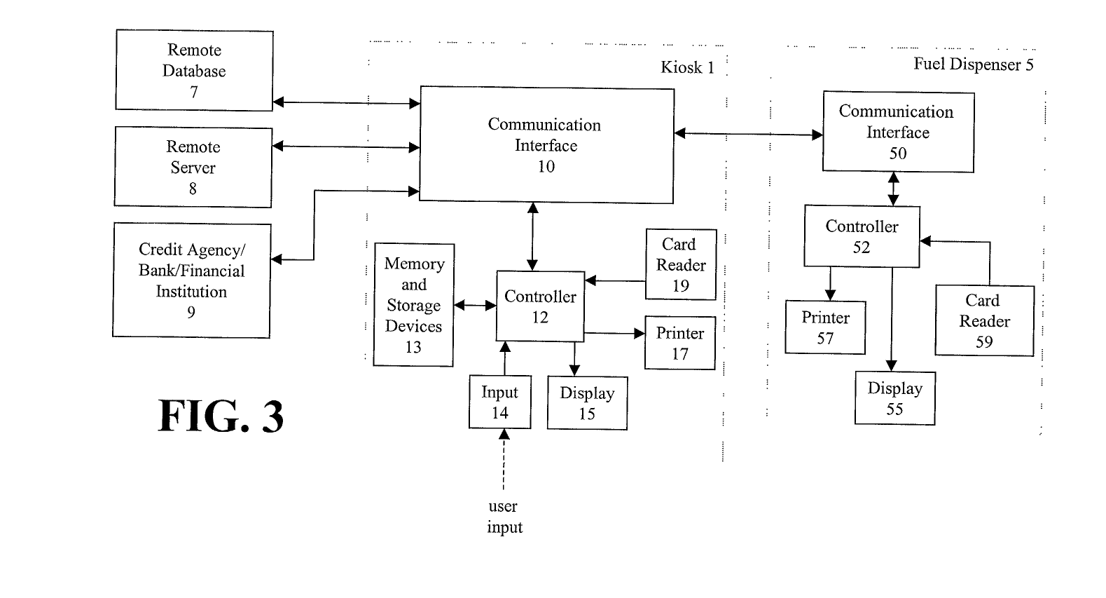

A system with a POS kiosk, according to an embodiment of the present invention, will be described with reference to FIG. 3.

Kiosk 1 may comprise communication interface 10, controller 12, memory and other storage devices 13, input devices 14, display 15, printer 17 and card reader 19.

In addition to card reader 19, the input devices may include a keypad, mouse, track ball, stylus, microphone, touch screen, etc., plus the appropriate device drivers and user interface software. Also, a speaker as well as other output devices may be included.

Communication interface 10 may include interfaces for connecting to the fuel dispenser 5 nearby, a remote database 7, remote server 8, and a credit agency (or other bank or financial institution) 9, as well as connecting to one or more other telecommunicative/computer networks, which may include the Internet, an intranet, an extranet, a LAN (local area network), a WAN (wide area network), a wireless network, a satellite network and other networks. For example, consumer profiles and/or demographics information may be downloaded through the networks from a remote centralized database. Communication interface 10 includes the appropriate units for interfacing with these networks, including, for example, Ethernet card, modem, wireless modem, etc.

The kiosk may communicate with the credit agency/database or other bank or financial institution through one or more wireless or landline telecommunicative networks. Interfaces, in any of many possible configurations that would be known to one skilled in the art, for such communication are well known. Therefore, the interface to the credit agency/database or other bank or financial institution is not described in detail here.

The kiosk also may communicate with a remote server. The remote server may provide content, such as advertising, news, traffic, sports, weather, other multimedia content, etc. The remote server may control information that may be displayed on the kiosk. For example, the remote server may control advertising to target the advertising based on demographics, customer profile, etc.

The communication interface includes an interface for the kiosk to communicate electronically with the fuel dispenser. The communication interface between the kiosk and the fuel dispenser depends in part on the fuel dispenser which may use any one of many different known interfaces. For example, the interface may include an RS-232 serial interface or some other standard interface.

A plurality of fuel dispensers may be connected through a network dispenser interface which functions as a server for the fuel dispensers. In another embodiment, the network dispenser interface may be a controller-type device.

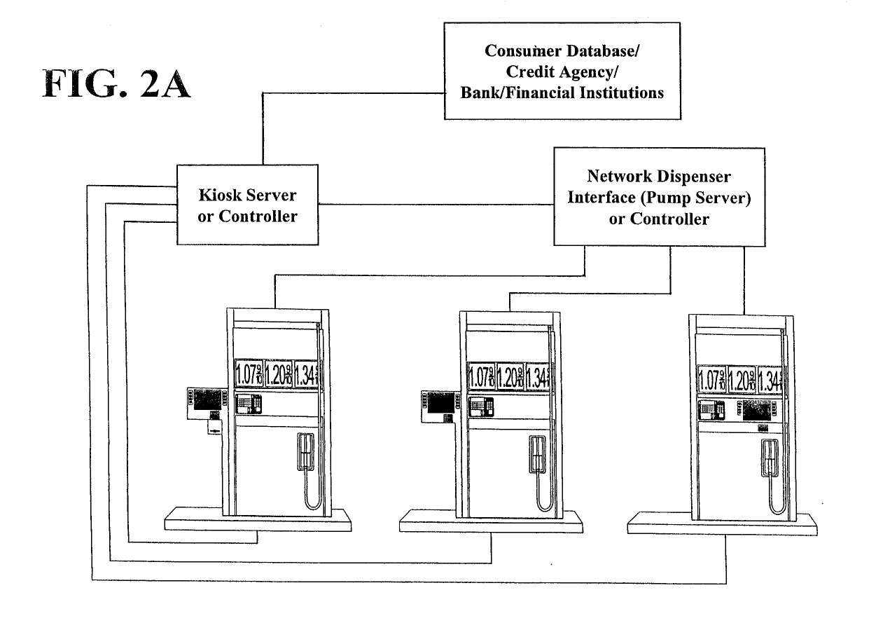

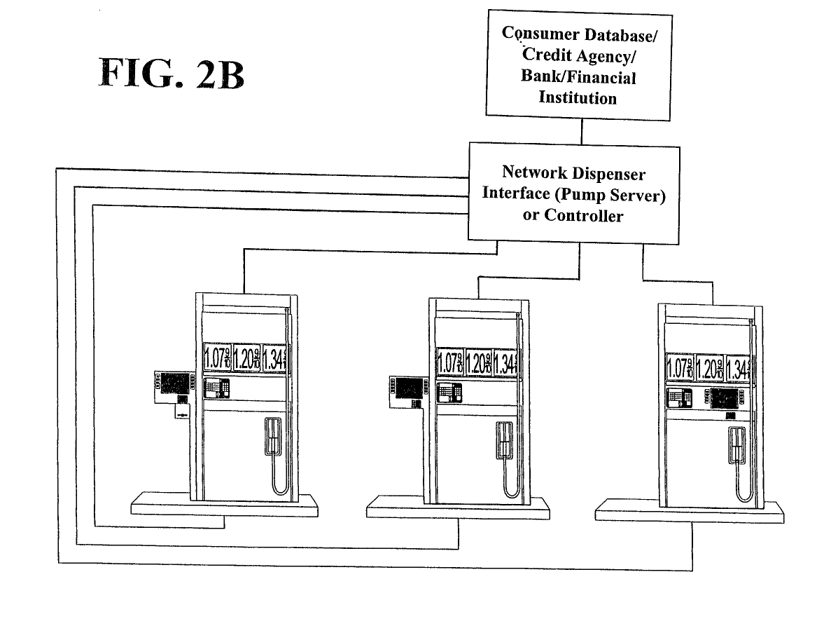

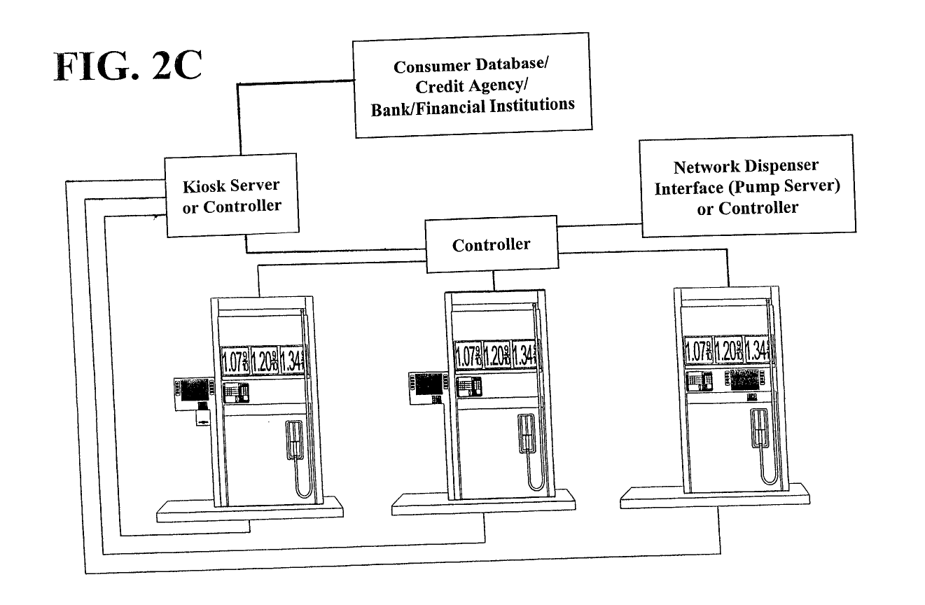

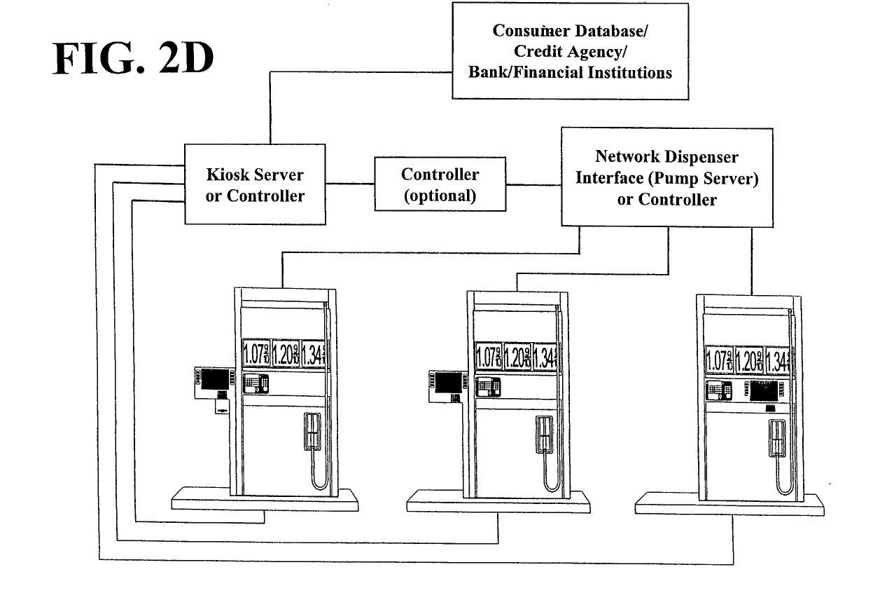

The communication schema between the kiosk and the fuel dispenser may be configured in one of many possible arrangements. For example, the kiosk may communicate, with (see, for example, FIG. 2A) or without (see, for example, FIG. 2B) going through a kiosk server (described in more detail below), via the network dispenser interface with the fuel dispenser. Also, an optional controller may be provided between the kiosk server and the network dispenser interface (see, for example, FIG. 2D). The kiosk may communicate, in accordance with another embodiment, directly with the fuel dispenser. In another embodiment, the kiosk may communicate through a kiosk server with the fuel dispenser, without going through the network dispenser interface (see, for example, FIG. 2C).

The kiosk has an electronic interface system through which the kiosk communicates with a credit agency or database. Also, the kiosk may communicate through a kiosk server (see, for example, FIGS. 2A and 2C) and/or through a network dispenser interface (see, for example, FIG. 2B) with the credit agency or database.

The kiosk server can receive and process requests from the kiosks to communicate, through the network dispenser interface, with one of the fuel dispensers, and requests to communicate with a credit agency and/or database. The kiosk server may receive/transmit, store and process information, data or graphics/video, in real-time or periodically, from/to various sources/destinations, such as a computer server, Web server, hand-held device server, in-vehicle navigation server, a satellite communication server and other internet servers. For example, the kiosk server may receive and store information from one of the sources mentioned above, process the information/data based on a kiosk's format requirement, and forward the processed information/data to the kiosk. In another embodiment, the kiosk server may be a controller-type device.

The memory devices may be one or a combination of buffers, registers and memories [for example, read-only memory (ROM), programmable ROM (PROM), erasable PROM (EPROM), electrically erasable PROM (EEPROM), non-volatile random access memory (NOVRAM), etc.]. The other storage devices may include, for example, floppy disk drive, CD (or DVD) drive and a hard disk, etc. The memory and storage devices store code and data for the controller 12.

Controller 12 coupled with software components control kiosk operations and functionalities. As shown, for example, in FIG. 3, controller 12 may be connected to each of the other components in the kiosk. Controller 12 may be one or more controller devices, including a suitably programmed microprocessor or microcontroller, an application specific integrated circuit (ASIC), a programmable logic device, or, as one skilled in the art would understand and appreciate, a collection of discrete components suitably laid out and connected on a printed circuit board.

The software components provide transaction processing functionalities and include assorted device drivers, including a wireless communication driver if a wireless interface is provided. The software components also may include transaction hardware management functions, a graphical user interface (including transaction card consumer interface), and interfaces to other software packages. For example, the software may provide speech recognition functionality, and a consumer may provide information to the kiosk by speaking into a microphone. This information might include any combination of name, address, phone number, ordering information, shipping information, etc.

In addition, the software components may provide digital media distribution functionalities. For example, wireless delivery of a “product” from the kiosk may be provided. The product sold at the kiosk may be a music download, via Bluetooth wireless MP3 or other wireless method. The consumer purchases the music at the kiosk. The music is downloaded to a device with the capability of downloading music via a wireless interface (for example, wireless MP3 player or standard other than MP3) in the car, or portable device on the consumer's person. Other examples of wirelessly distributed products include information, directions, software, tickets, lottery, coupons, etc.

The software components may be installed/stored in the memory and storage devices, and/or communicated through the communication interface via a network, such as the Internet, and/or a wireless transmission medium. Further, each software component may comprise one or more segments, subsets of which are retrieved, from the computer hard disk or via the network or transmission medium, as need arises.

The functionalities of the system may depend on the hardware and software implementation (for example, buttons and other actuators, as opposed to, or in combination with, graphical means on a touchscreen display). The functionalities may be combined/split or otherwise modified to ease the design, manufacture and serviceability of the system. Thus, functions may be implemented typically by, for example, a combination of software and hardware components.

The system includes displays and other components that can be used in outdoor environments. The components preferably can operate in all outdoor environments, ranging from the cold of winter to the heat of summer. High video/audio quality and operating performance in an outdoor environment, preferably coupled with interactivity, may be provided in order to capture and retain the attention of the customer, as well as effectively deliver product marketing and proper presentation of TV quality advertising. Although a high quality, interactive flat panel display is preferred, other liquid crystal displays, light-emitting diode display, cathode ray tube displays, and other display technologies may be used.

A method, in accordance with an embodiment of the present invention, for allowing customers to purchase merchandise at a POS kiosk located near (or inside) a gasoline dispenser by utilizing the credit/debit card information obtained from the gasoline purchase transaction may include, for example, the following steps:

(a) the customer swipes a credit or debit card through a card reader at the dispenser;

(b) card data is transmitted to a credit agency (or other bank or financial institution) for credit approval of the fuel purchase, and to the POS kiosk which holds the data pending a purchase transaction;

(c) an infomercial is displayed on a display screen and the customer decides to purchase an item by pressing button indicating desire to purchase;

(d) the credit card data is sent out to the credit agency for approval of merchandise purchase;

(e) the credit agency sends back an approval of the transaction, as well as name, address and other information on the credit record (the customer may be requested to enter additional data such as a zip code or telephone number to assist in locating the customer address);

(f) the address information, or an abbreviated version of the address information is displayed on the kiosk and confirmation of the purchase and the shipping address by the customer is requested;

(g) the customer confirms that the displayed shipping address is correct by pressing a button

(h) if displayed shipping address is correct, the transaction is completed and a receipt may be printed; and

(i) if the shipping address is not correct, the transaction is terminated, and the customer is advised to have their address of record updated and is given other options to complete the purchase transaction at a later time via telephone or internet.

Thus, customers may purchase merchandise and the merchandise is shipped to the customer, without requiring the customer to enter a name or address.

While embodiments of the present invention have been described in detail above, it should be understood that the invention is not limited to the precise embodiments described.

For example, while the kiosk is near, or integrated within, a fuel dispenser in the embodiments described above, the kiosk may be provided at other point-of-purchase locations, such as mass transit locations (e.g., bus stop/terminal, train station, airport, etc.), malls, fast food outlets and other high traffic locations where consumers may stop, with adaptations specific to those locations.

In addition, while the embodiments described above and in the appended claims refer to “a controller”, it should be apparent that the controller may comprise one or more suitably programmed general purpose or application specific controller-type devices.

Other improvements and modifications which become apparent to persons of ordinary skill in the art after reading this disclosure, the drawings and the appended claims are deemed within the spirit and scope of the present invention.

What is claimed is:

1. An apparatus for selling merchandise selected by a customer for purchase at a fuel dispenser, wherein the purchased merchandise is to be shipped to the customer, the apparatus comprising:
a user interface through which a user can select merchandise for purchase;
an electronic communication interface adapted to communicate electronically with the fuel dispenser; and
a controller coupled to the communication interface to communicate with the fuel dispenser, and adapted to monitor whether the fuel dispenser is being used, wherein, after determining that the fuel dispenser is being used, the controller triggers the user interface, and obtains through the communication interface customer information corresponding to a shipping address for the selected merchandise, with minimal or no input of information by the user for obtaining the shipping address.

2. The apparatus of claim 1, wherein the apparatus is a kiosk unit distinct from the fuel dispenser.

3. The apparatus of claim 1, wherein the apparatus communicates electronically with the fuel dispenser through the communication interface and a kiosk server.

4. The apparatus of claim 1, wherein the apparatus communicates electronically with the fuel dispenser through the communication interface and a network dispenser interface.

5. The apparatus of claim 1, wherein the apparatus communicates electronically with the fuel dispenser through the communication interface, a kiosk server and a network dispenser interface.

6. The apparatus of claim 1, wherein the apparatus communicates electronically with a credit agency, bank and/or a database to obtain the customer information through the communication interface and a kiosk server.

7. The apparatus of claim 1, wherein the apparatus communicates electronically with a credit agency, bank and/or a database to obtain the customer information through the communication interface and a network dispenser interface.

8. The apparatus of claim 1, wherein the apparatus communicates electronically with a credit agency, bank and/or a database to obtain the customer information through the communication interface, a kiosk server and a network dispenser interface.

9. The apparatus of claim 1, wherein the communication interface further comprises a second interface adapted to communicate electronically with a remote database, and the controller obtains through the second interface from the remote database the customer information corresponding to the shipping address for the selected merchandise.

10. The apparatus of claim 9, wherein the customer information obtained from the remote database includes a mailing address of the customer.

11. The apparatus of claim 9, wherein the customer information obtained from the remote database includes a code for obtaining a mailing address of the customer.

12. The apparatus of claim 9, wherein the remote database is associated with a web site.

13. The apparatus of claim 12, wherein a customer completes a transaction by one-push ordering.

14. The apparatus of claim 1, further comprising a card reader coupled to the controller, wherein the electronic communication interface further comprises a second interface adapted to communicate electronically with a consumer record database provider, the controller receives card data obtained by the card reader from a transaction card supplied by the customer, communicates the card data to the consumer record database provider and receives a confirmation along with cardholder address information from the consumer record database provider, through the second interface, and uses the cardholder address information to identify the shipping address for the selected merchandise.

15. The apparatus of claim 14, wherein the card reader is integrated within a housing of the fuel dispenser, and the controller receives through the electronic communication interface the card data obtained by the card reader.

16. The apparatus of claim 1, wherein the communication interface further comprises a second interface adapted to communicate electronically and wirelessly with a transponder device in a vehicle or a possession of the customer, and the controller obtains customer identification information through the second interface from the transponder device.

17. The apparatus of claim 16, wherein the controller obtains customer address information through the second interface from the transponder device and uses the customer address information to identify the shipping address for the selected merchandise.

18. The apparatus of claim 16, wherein the communication interface further comprises a third interface adapted to communicate electronically with a consumer record database provider, and the controller communicates through the third interface the customer identification information and receives a confirmation along with the customer address information from the consumer record database provider.

19. The apparatus of claim 1, wherein the communication interface further comprises a second interface adapted to communicate electronically and wirelessly with a transponder device in a vehicle or a possession of the customer, the selected merchandise includes digital media, and the digital media is delivered to the customer through the second interface.

20. The apparatus of claim 1, further comprising a printer, wherein a confirmation of the purchase order for the selected merchandise is printed by the printer.

21. The apparatus of claim 20, wherein the printer is integrated within a housing of the fuel dispenser, and the controller communicates with the fuel dispenser through the electronic communication interface to have the printer print a confirmation of the purchase order for the selected merchandise.

22. The apparatus of claim 1, wherein the communication interface further comprises a second interface adapted to communicate electronically with a supplier and/or fulfillment center of the selected merchandise, and the controller prepares an electronic purchase order for the selected merchandise, including the information corresponding to the shipping address, and communicates the electronic purchase order through the second interface to the supplier.

23. The apparatus of claim 1, wherein the user interface displays the shipping address, or an abbreviated version of the shipping address, and requests confirmation by the customer.

24. The apparatus of claim 1, wherein the user interface comprises a voice interface including a voice recognition component.

25. A method for selling merchandise selected by a customer for purchase at a fuel dispenser, wherein the purchased merchandise is to be shipped to the customer, the method comprising the steps of:
(a) providing a POS kiosk in a physical proximity of the fuel dispenser, wherein the POS kiosk has a controller and a communication interface;
(b) monitoring through the controller whether fuel is dispensed by the fuel dispenser;
(c) providing a user interface through which a user can select desired merchandise, after it is determined in step (b) that fuel is being dispensed by the fuel dispenser; and
(d) communicating electronically from the POS kiosk through the communication interface to obtain customer information corresponding to a shipping address for the selected merchandise, without input of the shipping address by the user.

26. A method for selling merchandise selected by a customer for purchase at a fuel dispenser using a POS kiosk in a physical proximity of a fuel dispenser, the POS kiosk having a controller and a communication interface, wherein the purchased merchandise is to be shipped to the customer, the method comprising the steps of:
(a) monitoring through the controller whether fuel is dispensed by the fuel dispenser;
(b) providing a user interface through which a user can select desired merchandise, after it is determined in step (a) that fuel is being dispensed by the fuel dispenser; and
(c) communicating electronically from the POS kiosk through the communication interface to obtain customer information corresponding to a shipping address for the selected merchandise, with minimal or no input of information by the user for obtaining the shipping address.

27. The method of claim 26, further comprising receiving a signal at the POS kiosk from the fuel dispenser when a fuel purchase transaction commences at the fuel dispenser.

28. The method of claim 26, further comprising receiving a signal at the POS kiosk from the fuel dispenser when a fuel pump handle at the fuel dispenser has been lifted from a resting position.

29. The method of claim 26, wherein the POS kiosk communicates electronically with a consumer record database provider to obtain the customer information through the communication interface and a kiosk server.

30. The method of claim 26, wherein the POS kiosk communicates electronically with a credit agency and/or a database to obtain the customer information through the communication interface and a network dispenser interface.

31. The method of claim 26, wherein the POS kiosk communicates electronically with a consumer record database provider to obtain the customer information through the communication interface, a kiosk server and a network dispenser interface.

32. The method of claim 26, further comprising reading card data from a transaction card supplied by the user through a card reader integrated with the POS kiosk, wherein transaction data and the card data are communicated electronically through the communication interface from the POS kiosk to a credit agency, bank or other financial institution to request approval of credit for the merchandise transaction, and a confirmation is received along with cardholder address information from the credit agency.

33. The method of claim 26, further comprising receiving card data from the fuel dispenser read from a transaction card supplied by the user through a card reader integrated with the fuel dispenser, wherein transaction data and the card data are communicated electronically through the communication interface from the POS kiosk to a credit agency to request approval of credit for the merchandise transaction, and receiving a confirmation along with cardholder address information from the credit agency.

34. The method of claim 26, wherein the POS kiosk communicates electronically through the communication interface with a remote database to obtain from the remote database the customer information corresponding to the shipping address for the selected merchandise.

35. The method of claim 34, wherein the customer information obtained from the remote database includes a mailing address of the customer.

36. The method of claim 34, wherein the customer information obtained from the remote database includes a code for obtaining a mailing address of the customer.

37. The method of claim 26, further comprising adding to a fuel purchase transaction at the fuel dispenser a purchase of the selected merchandise.

38. The method of claim 26, further comprising printing a receipt for the selected merchandise through a printer integrated within a housing of the fuel dispenser.

39. The method of claim 26, further comprising printing a receipt for the selected merchandise through a printer integrated with the POS kiosk.

40. The method of claim 26, wherein the POS kiosk communicates electronically with the fuel dispenser through the communication interface and a kiosk server.

41. The method of claim 26, wherein the POS kiosk communicates electronically with the fuel dispenser through the communication interface and a network dispenser interface.

42. The method of claim 26, wherein the POS kiosk communicates electronically with the fuel dispenser through the communication interface, a kiosk server and a network dispenser interface.
